(19) United States
(12) Patent Application Publication
(10) Pub. No.: US 2002/0053998 A1
(43) Pub. Date: May 9, 2002

(54) Plasma display module

(75) Inventors: Hiroshi Suetsugu, Tokyo (JP); Taku Ohzono, Tokyo (JP)

Correspondence Address: Norman P. Soloway, HAYES, SOLOWAY, HENNESSEY, GROSSMAN & HAGE, P.C., 175 Canal Street, Manchester, NH, 03101, US

(73) Assignee: NEC Corporation

(21) Appl. No.: 10/008,856

(22) Filed: Nov. 8, 2001

(30) Foreign Application Priority Data
Nov. 8, 2000 (JP) 2000-340437

(51) Int. Cl. G09G 3/20

(52) U.S. Cl. 345/55

(57) ABSTRACT

A plasma display panel, driving circuits for driving the plasma display panel, and a power circuit into which an external alternating current is inputted are provided to a plasma display module. The power circuit supplies driving voltages to the driving circuits. The power circuit outputs an external source voltage to be used by an external power circuit and a control voltage for controlling operations of an interface board to which source voltages of the interface board are supplied from the external power circuit. Furthermore, operations of the power circuit are controlled with control signals output by the interface board.

### BACKGROUND OF THE INVENTION

1. Field of the Invention

The present invention relates to a plasma display module to be integrated into a plasma display and, more particularly, to a plasma display module wherein a power circuit can be easily designed.

2. Description of the Related Art

FIG. 1 is a block diagram showing a prior plasma display. A power circuit 8 is provided to the prior plasma display. The power circuit 8 includes a power circuit for driving a plasma display module and a power circuit for driving an interface board. The interface board is used to, for example, analog/digital convert an analog image input signal and output a digital image signal.

A source voltage necessary to drive the interface board is designed by a plasma display manufacturer and depends on an integrated circuit (IC) which has been customized for each manufacturer. Accordingly, the source voltage varies from one manufacturer to another and has not been standardized. For example, the source voltage can be 3.3V, 5V, 7V, or 12V.

Accordingly, in a case where the plasma display manufacturer develops a power source, it is necessary to newly develop an integrated power circuit to drive both the interface board and plasma display module.

On the other hand, as a power source to drive the plasma display module, a high-voltage and high-capacity power source is necessary. Therefore, in order to develop such an integrated power circuit, there is a problem in that a great amount of costs and man-hours become necessary.

### SUMMARY OF THE INVENTION

It is an object of the present invention to provide a plasma display module for which the development costs and man-hours for development of a power circuit by a plasma display manufacturer can be reduced.

A plasma display module according to the present invention comprises: a plasma display panel; driving circuits which drives the plasma display panel; and a power circuit into which an external alternating current is inputted from outward. The power circuit supplies driving voltages to the driving circuits. The power circuit outputs an external source voltage to be used by an external power circuit and a control voltage for controlling operations of an interface board to which source voltages of the interface board are supplied from the external circuit. Operations of the power circuit are controlled with control signals output by the interface board.

In the present invention, the power circuit for supplying a source voltage to the driving circuit is provided in the plasma display module, accordingly the power circuit is supplied by a plasma display module manufacturer. Therefore, when a plasma display manufacturer develops a plasma display, this can be carried out by only designing an interface board which A/D converts an analogue image input signal and outputs a digital image signal and an external power circuit for driving the the interface board. Accordingly, the development costs and man-hours for development of the power circuit can be reduced.

In addition, since the power circuit is delivered after being integrated into a plasma display module, the plasma display manufacturer can omit adjustment of the driving voltages. Also therein, man-hours can be reduced.

### BRIEF DESCRIPTION OF THE DRAWINGS

FIG. 1 is a block diagram showing a prior plasma display panel.

FIG. 2 is a block diagram showing a construction of a plasma display module with a power source according to an embodiment of the present invention.

FIG. 3 is a block diagram showing a plasma display using the plasma display module with a power source shown in FIG. 2.

FIG. 4 is a timing chart showing operations of the plasma display shown in FIG. 3.

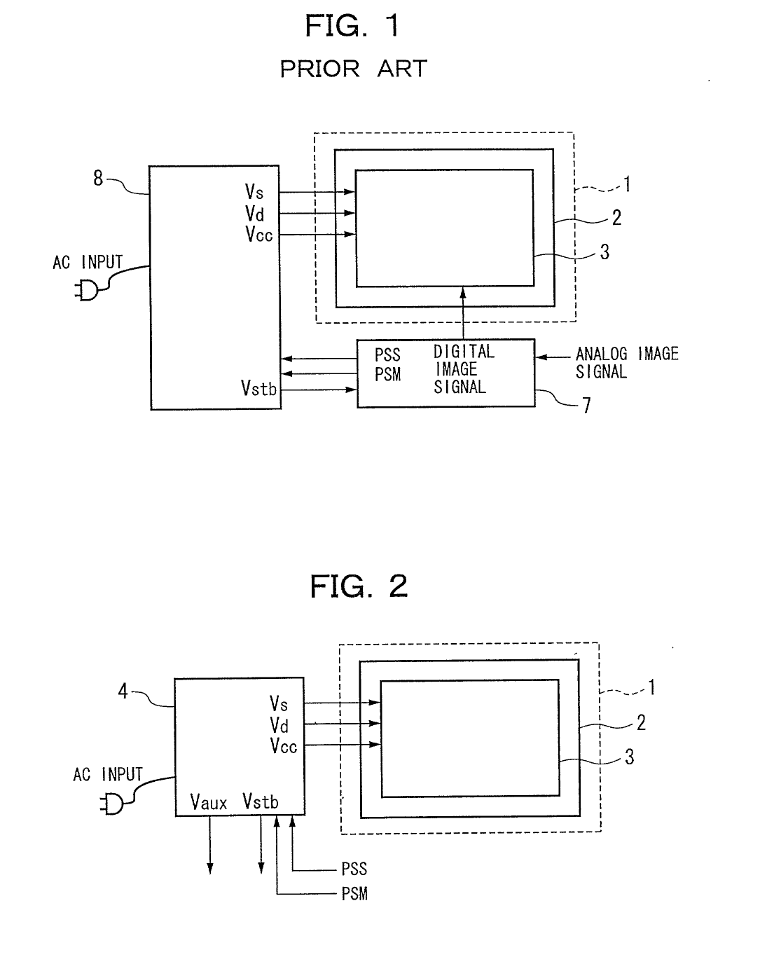

### DETAILED DESCRIPTION OF THE PREFERRED EMBODIMENTS

Hereinafter, a preferred embodiment of the present invention will be described in detail with reference to the attached drawings. FIG. 2 is a block diagram showing a construction of a plasma display module with a power source according to an embodiment of the present invention.

A plasma display panel 2 and a driving circuit 3 for driving the plasma display panel 2 are provided to a plasma display module 1.

A power circuit 4 which generates source voltages for driving the plasma display module 1 receives inputs of an AC power source, a control signal PSS, and a control signal PSM. The power circuit 4 outputs a control voltage Vstb, a power voltage Vaux, and a driving voltage group to be supplied to the driving circuit 3. The driving voltage group consists of a power voltage Vcc of, for example, 5V, a source voltage for data electrodes Vd of, for example, 60V, and a source voltage for sustaining electrodes of, for example, 160V, however, other voltages may be included in the driving voltage group.

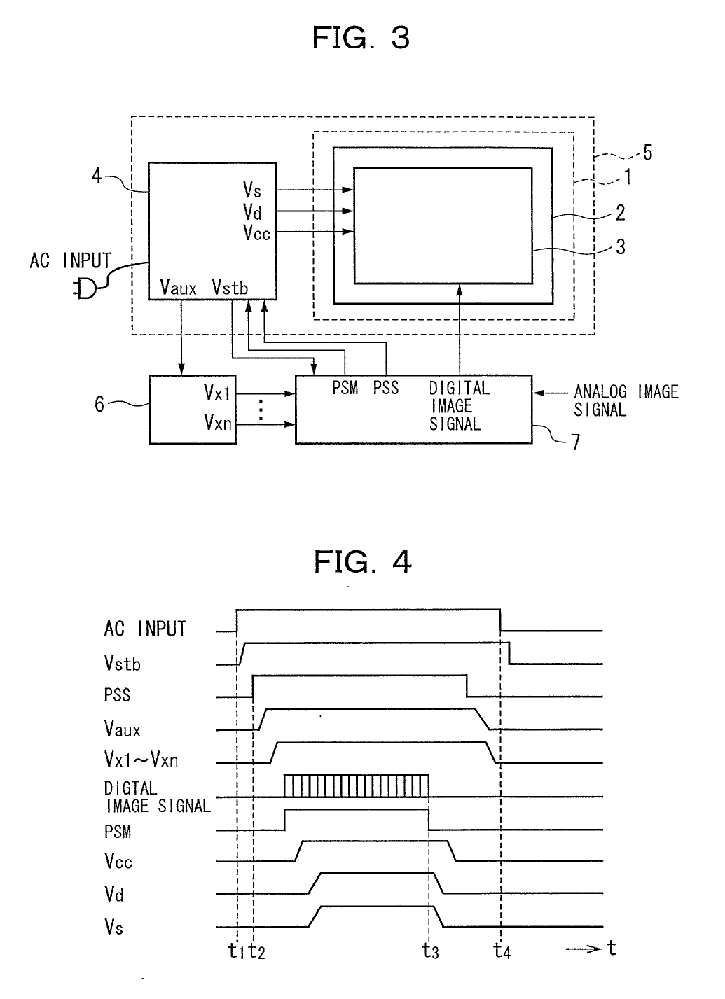

FIG. 3 is a block diagram showing a plasma display using the plasma display module with a power source shown in FIG. 2. In a case where the plasma display module 5 with a power source shown in FIG. 2 is incorporated into a plasma display, for example, an interface board 7 which A/D converts an analogue image input signal and outputs a digital image signal, and a power circuit 6 which generates source voltages for driving the interface board 7 are provided. The source voltage Vaux is supplied to the power circuit 6 and the control voltage Vstb is supplied to the interface board 7. On the other hand, the control signals PSS and PSM are output from the interface board 7 to the power circuit 4. N types of source voltages Vx1 through Vxn are supplied from the power circuit 6 to the interface board 7. Voltages of, for example, 3.3V, 5V, and 7V are included in the source voltages Vx1 thorough Vxn. In addition, an analogue image signal is inputted into the interface board 7. A digital image signal which is obtained through conversion by an A/D converter that is built in the interface board 7 is inputted into the driving circuit 3.

Thereafter, operations of the plasma display constructed as mentioned above will be described. FIG. 4 is a timing chart showing operations of the plasma display shown in FIG. 3.

First, a description will be given of operations when starting up the power source.

When the AC power source is inputted at time t1, the control voltage Vstb becomes high level and the plasma display reaches a stand-by state.

When a power source of the plasma display is turned on at time t2, a control portion of the interface board 7 starts to operate and the control signal PSS becomes high level.

The power circuit 4 makes, when the high-level control signal PSS is inputted thereto, the source voltage Vaux high level. In addition, the power circuit 6 makes, when the high-level source voltage Vaux is inputted thereto, the source voltages Vx1 through Vxn high level. As a result, the interface board 7 starts A/D conversion.

The interface board 7 begins to supply the digital image signal to the driving circuit 3 and simultaneously makes the control signal PSM high level.

The power circuit 4 makes, when the high-level control signal PSM is inputted thereto, the low source voltage Vcc high level and then makes the high power voltages Vd and Vs high level in turn. As a result, the plasma display panel 2 can display an image. If a high power voltage is started up earlier than a low power voltage, a high voltage circuit may have floating gate levels and a penetration current may flow, causing damage to the high voltage circuit. For the prevention of the damage, in the present embodiment, the high power voltages Vd and Vs are made high level after the low power voltage Vcc is made high level.

Thereafter, a description will be given of operations when shutting down the power source.

When a power source of the plasma display is turned off at time t3, the interface board 7 stops outputting the digital image signal and simultaneously makes the control signal PSM low level.

When the control signal PSM becomes low level, the power circuit 4 makes the source voltages Vd and Vs low level and then makes the source voltage Vcc low level.

Thereafter, after an elapse of a predetermined time of, for example, 200 m seconds, the interface board 7 makes the control signal PSS low level.

When the control signal PSS becomes low level, the power circuit 4 makes the source voltage Vaux low level. When the source voltage Vaux becomes low level, the power circuit 6 makes the source voltages Vx1 through Vxn low level. As a result, the plasma display reaches a stand-by state.

Thereafter, when the AC power source is disconnected at time t4, the power circuit 4 makes the control voltage Vstb low level and the stand-by state is cancelled.

What is claimed is:

1. A plasma display module comprises:
a plasma display panel;
driving circuits which drive said plasma display panel; and
a power circuit into which an external alternating current is inputted from outward, said power circuit supplying driving voltages to said driving circuits, and outputting an external source voltage to be used by an external power circuit and a control voltage for controlling operations of an interface board to which source voltages of said interface board are supplied from said external power circuit, and operations of said power circuit being controlled with control signals output by said interface board.

2. A plasma display module according to claim 1, wherein said control signals output by said interface board contain first and second control signals, and said power circuit outputs said control voltage to said interface board when said external alternating current is inputted to said power circuit, outputs said external power voltage to said external power circuit when said first control signal is inputted to said power circuit, and outputs said driving voltages to said driving circuits when said second control signal is inputted to said power circuit.

3. A plasma display module according to claim 1, wherein said driving voltages contain a plurality of voltages having different values, and said power circuit starts up a lowest-value voltage of said plurality of voltages earlier than a highest-value voltage of said plurality of voltages.

4. A plasma display module according to claim 1, wherein said driving voltages contain a plurality of voltages having different values, and said power circuit shuts down a highest-value voltage of said plurality of voltages earlier than a lowest-value voltage of said plurality of voltages.

5. A plasma display module according to claim 1, wherein said driving voltages contain a plurality of voltages having different values, and said power circuit starts up a lowest-value voltage of said plurality of voltages earlier than a highest-value voltage of said plurality of voltages and shuts down said highest-value voltage earlier than said lowest-value voltage.

6. A plasma display module according to claim 2, wherein said driving voltages contain a plurality of voltages having different values, and said power circuit starts up a lowest-value voltage of said plurality of voltages earlier than a highest-value voltage of said plurality of voltages.

7. A plasma display module according to claim 2, wherein said driving voltages contain a plurality of voltages having different values, and said power circuit shuts down a highest-value voltage of said plurality of voltages earlier than a lowest-value voltage of said plurality of voltages.

8. A plasma display module according to claim 2, wherein said driving voltages contain a plurality of voltages having different values, and said power circuit starts up a lowest-value voltage of said plurality of voltages earlier than a highest-value voltage of said plurality of voltages and shuts down said highest-value voltage earlier than said lowest-value voltage.
